(19) United States
(12) Patent Application Publication
(10) Pub. No.: US 2007/0189621 A1
(43) Pub. Date: Aug. 16, 2007

(54) Image transmission system

(75) Inventor: Chien-Hsing Liu, Taipei Hsien (TW)

Correspondence Address: BIRCH STEWART KOLASCH & BIRCH, PO BOX 747, FALLS CHURCH, VA, 22040-0747, US

(73) Assignee: ATEN INTERNATIONAL CO., LTD

(21) Appl. No.: 11/354,107

(22) Filed: Feb. 15, 2006

(51) Int. Cl. G06K 9/36

(52) U.S. Cl. 382/239

(57) ABSTRACT

The present image compression system of the present invention adopts a variety of compression criteria by dynamically adjusting the sampling modes and quantization formats based on a plurality of thresholds. The present image compression system uses an analyzer compares two image data stored in two buffers to determine one of the sampling modes and quantization formats based on the pixel value change between two consecutive image data. Once the pixel value change moves from one threshold to another threshold, the sampling modes and the quantization formats may be changed.

### FIELD OF THE INVENTION

The present invention relates to an image transmission system, and more particularly, to a compression system that can dynamically adjust the sampling modes and quantization formats.

### BACKGROUND OF THE INVENTION

In recent years, due to explosive development and wide spread of computers and their networks, a variety of information such as text data, image data and voice data have been digitized. These digitized data may be transmitted through the Internet to users.

Conventionally, when transmitting, a same sampling mode and quantization table are used to process digitized data. Such a processing method is acceptable when the digitized data is text data having smooth pixel value changes between consecutive frames.

However, both drastic pixel value changes and smooth pixel value changes typically exist together in continuous image data. Therefore, it is not enough to use only one kind of sampling mode and quantization format to process image data. For example, a lossless sampling mode and a higher quantization table should be used to improve the contrast between two consecutive frames having smooth pixel value change. On the contrary, when a large pixel change exists between two consecutive frames, a lossy sampling mode and a lower quality quantization table may be selected to process this image data because an obvious contrast exists between the two consecutive frames.

Therefore, a compression system that can dynamically adjust the sampling mode and quantization table is required.

### SUMMARY OF THE INVENTION

Therefore, it is the main purpose of the present invention to provide a compression and decompression system that can dynamically adjust the sampling mode and quantization table.

Another purpose of the present invention is to provide a compression and decompression system that can dynamically adjust the sampling mode and quantization table based on the pixel value change between two consecutive frames to reduce the amount of data so as to enable faster image transmission.

Another purpose of the present invention is to provide a compression and decompression system that may adjust the sampling mode and quantization table based on the pixel value change between two consecutive frames so as to reduce the amount of time and computing resources needed to encode and decode an image.

The problems outlined above are solved by the apparatus of the present invention. That is, the image compression system of the present invention includes two bufferes for respectively storing two consecutive image data, a subtractor and an analyzer. The subtractor caculates the residual between the two frames. The analyzer compares the two frames to determine a sampling mode and quantization table based on the volume of residual data send from subtractor.

For give consideration to image quality and transmission velocity, the selection of quantization table and sampling mode is determined by the area of a variation block. A higher compression rate of quantization table and sampling mode is selected when the block has a larger area. A lower compression rate of quantization table and sampling mode is selected when the block has a smaleer area.

Therefore, the compression system may get a balance point between the image quality and the image data volume.

The image compression system of the present invention further has a selector coupled to three samplers. This analyzer switches the selector to select one of the three samplers to process this image data based on the volume of all pixel value change between two consecutive image data. The three samplers respectively provide three different sampling modes, a first sampling mode, a second sampling mode and a third sampling mode.

In an embodiment, the first sampling mode is a “411 sampling mode”. The second sampling mode is a “422 sampling mode”. The third sampling mode is a “444 sampling mode”.

The image compression system of the present invention further provides a selector coupled to two quantization tables. This analyzer switches the selector to select one of the two quantization tables to process the image data based on the volume of all pixel value change between two consecutive image data.

The image compression system of the present invention further has a header adder coupled to the two selectors. These two selectors inform the adder which sampler and quantization table are selected. Then, a specific number is added in the header to indicate a specific combination of sampling mode and quantization table.

The image decompression system of the present invention includes a header picker to resolve the header to determine which sampler and quantization table are selected in the compression system.

The image decompression system of the present invention further has a selector coupled to two quantization tables. This selector is informed by the header picker which quantization table is selected. Based on the information, a specific quantization table is switched to process the image data by the selector.

The image decompression system of the present invention further provides a selector coupled to three samplers. This selector is informed by the header picker which sampler is selected. Based on the information, a specific sampler is switched to process the image data by the selector. The three samplers respectively provide three different sampling modes, a first sampling mode, a second sampling mode and a third sampling mode.

In an embodiment, the first sampling mode is a “411 sampling mode”. The second sampling mode is a “422 sampling mode”. The third sampling mode is a “444 sampling mode”.

Moreover, according to the present invention, for avoiding the selectors being frequently switched, a motion image area determination method is provided. This method provides selecting between two types of compression mode to process motion image data. When the number of all motion pixels is located in those areas, the present invention forces the two selectors to select the sampler and quantization table that is similar to the previous compressing process.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 is a block diagram of a system for dynamically adjusting processing data modes in accordance with the present invention;

FIG. 2 is a detailed diagram of the transmitting system for dynamically adjusting processing data modes in accordance with the present invention;

FIG. 3 is a detailed diagram of the receiving system for dynamically adjusting processing data modes in accordance with the present invention;

FIG. 4 is a detailed diagram of the transmitting system for dynamically adjusting processing data modes in accordance with another embodiment of the present invention;

FIG. 5 illustrates six types of compression format provided by the present invention;

FIG. 6 is a detailed diagram of the receiving system for dynamically adjusting processing data modes in accordance with another embodiment of the present invention; and

FIG. 7 is a diagram of the analyzer to determine which sampler and quantization table is selected.

### DETAILED DESCRIPTION OF THE PREFERRED EMBODIMENT

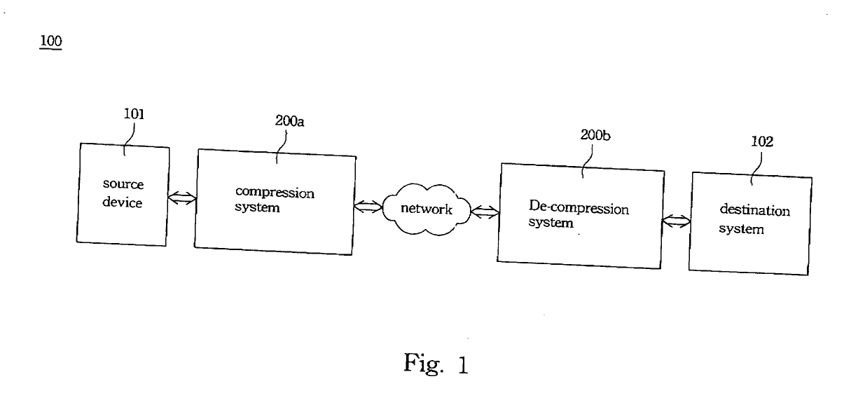

FIG. 1 is a block diagram for dynamically adjusting processing data modes in accordance with the present invention. In FIG. 1, the system 100 includes at least one source device 101, at least one destination device 102, a compression system 200a, and a decompression system 200b. The source device can be a computing device or a video camera, which provides image data, for example. The destination device is a display, for example. The present invention provides the compression system 200a and the decompression system 200b for dynamically adjusting processing data modes between the source device 101 and the destination device 102. The compression system 200a and the decompression system 200b are in further detail described in the following paragraphs.

In general, system 200a and 200b control the type of data transfer modes among the source devices 101 and destination devices 102. As will be described subsequently in further detail, system 200a and 200b are enabled to control data transfer mode (e.g., sampling mode and quantization table) between the source 101 and destination devices 102 based on the corresponding pixel value change between two consecutive images.

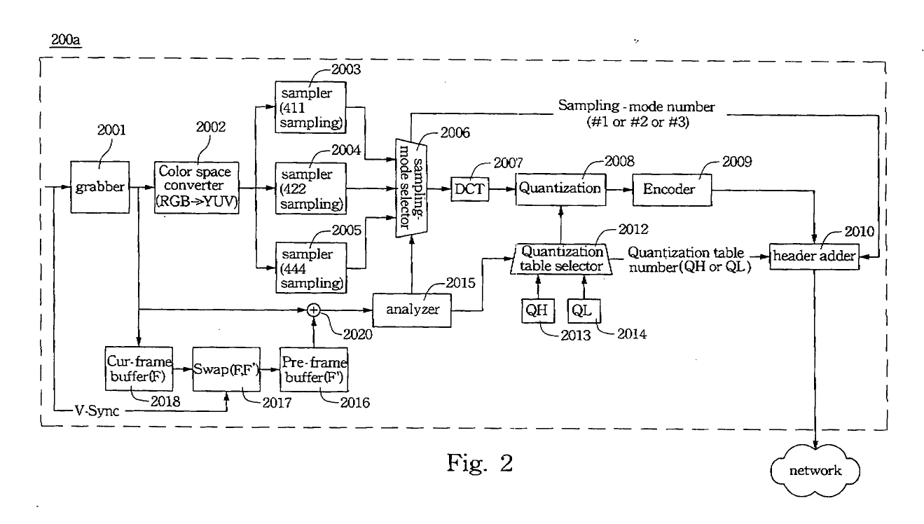

FIG. 2 is a detailed diagram of the system 200a, shown in FIG. 1, for dynamically adjusting processing data modes in accordance with the present invention. According to the present invention, a grabber 2001 is used to grab an image data from the source device 100 shown in FIG. 1. First, the image data is transformed into a suitable color space by a color space converter 2002. Typically, for color images, an RGB image data is transformed into a luminance/chrominance color space (YCbCr, YUV, etc). The luminance component is gray scale and the other two axes are color information.

Then, this transformed color image data is transmitted to samplers 2003, 2004 and 2005 for sampling each component by averaging together groups of pixels. Typically, because the human eye is not as sensitive to high-frequency chroma infomation as it is to high-frequency luminance, much more information in the luminance component is required than in the chrominance components. Therefore, when the image data is sampled, the luminance component is left at full resolution, while the chroma components are often reduced 2:1 horizontally and either 2:1 or 1:1 vertically.

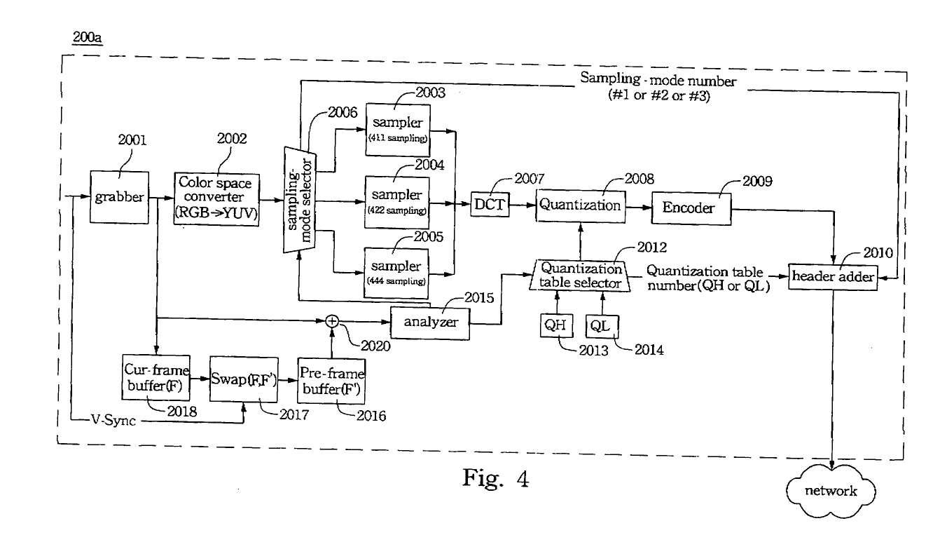

In JPEG format, these are so-called “411” and “422” sampling mode that are performed by a first sampler 2003 and a second sampler 2004, respectively. Moreover, both the luminance component and the chroma components are left at full resolution, which is called “444” sampling mode that is performed by a third sampler 2005. Through the first sampler 2003 and the second sampler 2004, the data volume is reduced by one-half or one-third. According to this invention, a sampling mode selector 2006 is coupled with the three samplers 2003, 2004 and 2005 to select one of them for sampling this transformed color image data. The sampling mode selector 2006 can be a multiplexer or the like. It is noticed that the sampling mode selector 2006 also may be connected between the color space converter 2002 and the three samplers 2003, 2004 and 2005 as shown in the FIG. 4. The three samplers respectively provide three different sampling modes, a first sampling mode, a second sampling mode and a third sampling mode. In an embodiment, the first sampling mode is a “411 sampling mode”. The second sampling mode is a “422 sampling mode”. The third sampling mode is a “444 sampling mode”.

Moreover, in this invention, a Pre-frame buffer 2016 and a Cur-frame buffer 2018 are used to store a sequence of video image data. The Pre-frame buffer 2016 and the Cur-frame buffer 2018 are connected together through a swap 2017. The swap 2017 is used to tramsmit the frame of the image data from Cur-frame buffer 2018 to the Pre-frame buffer 2016 based on the V-sync signal that is the vertical synchronization of the source device 101. The Cur-frame buffer 2018 is coupled to the grabber 2001 for receiving fram of the image data, called the first frame, from the source device 100 shown in FIG. 1. When the next frame of the image data, called the second frame, is generated and grabbed by the grabber 2001, the first frame originally stored in the Cur-frame buffer 2018 is swapped to the Pre-frame buffer 2016 by the swap 2017 and this second frame is stored in the Cur-frame buffer 2018.

The two frame respectively stored in the Pre-frame buffers 2016 and the Cur-frame buffer 2018 are together sent to a subtractor 2020. The subtractor 2020 calculates the motion pixel that is experiencing data change to determine which sampling mode and quantization table should be selected.

This motion pixel volume is sent to an analyzer 2015. For dynamically adjusting the sampling mode, the analyzer 2015 is used to analyze the volume of the motion pixel so as to control the sampling mode selector 2006 to select one of the samplers 2003, 2004 and 2005 for sampling image data based on the analysis. According to this invention, a first and a second control signals are outputted from the analyzer 2015 to respectively control the switching of the sampling mode selector 2006 and quantization table selector 2012.

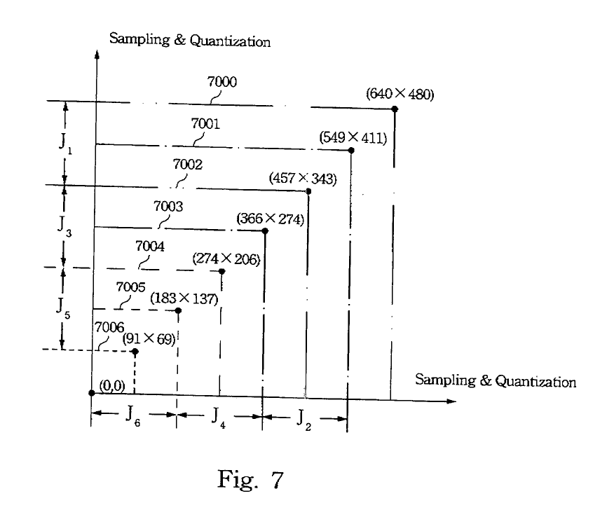

For example, please referring to FIG. 2 and FIG. 7, when the volume of all motion pixel calculated by the subtractor 2020 is located in the area between the threshold 7000 and the threshold 7002, a J1 type compressed format is selected by the analyzer 2015. The analyzer 2015 may send a first control signal to the sampling mode eslector 2006 to select the sampler 2003 to sample the image data and a second control signal to the Quantization table selector 2012 to select QL table 2014 to quantize the image data. In other example, when the volume of all motion pixel calculated by the subtractor 2020 in the area between the threshold 7002 and the threshold 7004, a J3 type compressed format is selected by the analyzer 2015. The analyzer 2015 may send a first control signal to the sampling mode eslector 2006 to select the sampler 2004 to sample the image data and a second control signal to the Quantization table selector 2012 to select QH table 2013 to quantize the image data. In other words, the subtractor 2020 caculates the volume of the motion pixel between two frames. Then, the analyzer 2015 determines a sampling mode and quantization table based on the volume of motion pixel send from subtractor 2020.

The sampled image data is transmitted from the sampling mode selector 2006 to a discrete cosine transform (DCT) 2007 block. In an embodiment, the image data in a frame are grouped into a plurality of blocks, each of which has 8×8 pixels, for example. Each block is transformed through the DCT 2007. The DCT 2007 performs Fourier transform and gives a frequency map of each block. That is, each block has 64 frequency components. The DCT 2007 performs a discret cosin transform to transform an image data from a spatial domain to a frequency domain.

These frequency component data are transmitted from the DCT 2007 to quantization 2008. In the quantization 2008, each of the 64 frequency components of each block is divided by a “quantization coefficient” and rounded to integers. Therefore, the larger the quantization coefficients selected, the more data is discarded. In other words, the data size is reduced. On the contrary, the smaller the quantization coefficients selected, the more data is reserved. Therefroe, the data size is larger.

Since higher frequency data are less visible to the human eye, they are always quantized less accurately by larger coefficients than lower. Therefore, based on the human eye limitation, the image data are processed by different quantization tables. According to the present invention, two quantization tables 2013 and 2014 with different quantization coefficients are used to quantize the image data transformed by DCT 2007 operation. The first quantization tables 2013, QH, has smaller quantization coefficients so that a high quality image data is obtained. The second quantization tables 2014, QL, has larger quantization coefficients so that a lower quality image data is obtained.

A quantization table selector 2012 is used to switch between the two quantization tables 2013 and 2014 to quantization 2008 block. The quantization table selector 2012 is controlled by the analyzer 2015. In other words, based on the analysis described above, the analyzer 2015 may send two control signals to the sampling mode selector 2006 and quantization table selector 2012 to switch the samplers 2003-2005 and the quantization table respectively to process the image data. Quantization techniques generally compress for compressing a range of values to a single quantum value.

After the image data is processed by the quantization 2008 block, this image data is encoded by the encoder 2009, typically using either Huffman or arithmetic coding. The encoded data are tramsmitted to a header adder 2010 to track on appropriate headers and output the result to the network shown in FIG. 1.

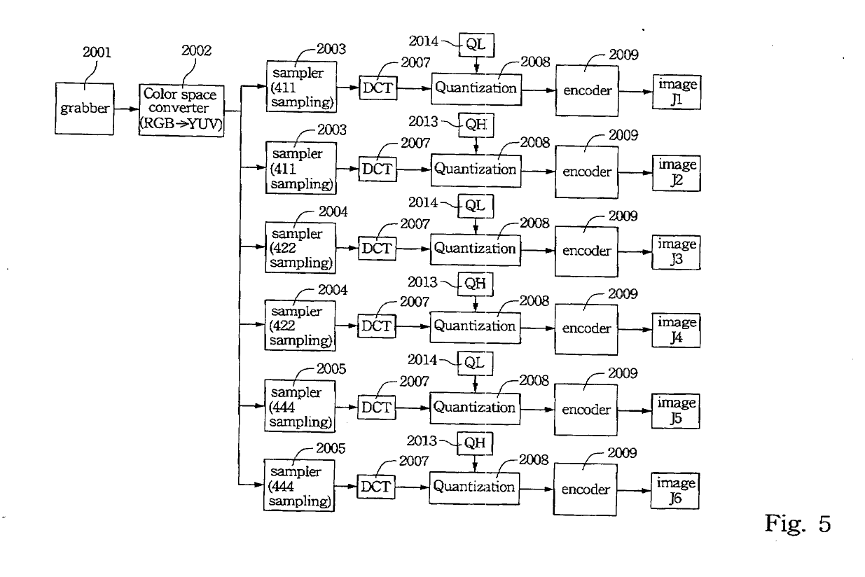

According to the present invention, the three samplers 2003, 2004 and 2005 and the two quantization tables 2013 and 2014 may together determine six combinations to process the image data. FIG. 5 illustrates the six combinations provided by the present invention. For example, after an image data is grabbed by the grabber 2001 and transformed into a suitable color space by the converter 2002, the analyzer 2015 based on the frequency data of the chroma and luminance determines to use a “411” sampling mode and a low quality quantization table (QL) to process this image.

At this time, the sampler 2003 and the quantization table 2014 are switched to process this image data. This image data processed by a “411” sampling mode and quality quantization table (QL) is called Image J1. Similarly, when the analyzer 2015 determines to use a “411”, sampling mode and a high quality quantization table (QH) to process this image, the sampler 2003 and the quantization table 2013 are switched to process this image data. The image data processed by a “411” sampling mode and quantization table (QH) is called Image J2. The rest may be deduced by analogy. The image data processed by a “422” sampling mode and quantization table (QL) is called Image J3. The image data processed by “422” sampling mode and quantization table (QH) is called Image J4. The image data processed by a “444” sampling mode and quantization table (QL) is called Image J5. The image data processed by a “444” sampling mode and quantization table (QH) is called Image J6. Accordingly, the lossless sampling mode and the higher quality quantization table are selected, the larger image data size is obtained. Therefore, the image data size comparison is J6>J5>J4>J3>J2>J1. The image quality comparison is J6>J5>J4>J3>J2>J1.

Each of the compression parameters is included in a header so that the decompressor in the De-compression system 200b shown in FIG. 1 can reverse the process based on the received header. These compression parameters include the information of the adopted quantization tables type and the sampling mode. The quantization table selector 2012 may transmit a result signal to the header adder 2010 to inform the adder 2010 which table is selected.

The sampling mode selector 2006 also may transmit a result signal to inform the adder 2010 which sampling mode is selected. According to the present invention, six processing combinations are provided. Therefore, a number representing a specific processing parameter is included in the header to inform the decompressor what kind of quantization table and sampling mode is used. In other words, compare to standard JPEG format image file, those quatization tables can be omitted. This saves several hundred bytes of overhead. Finally, a compressed image data is sent out from the system 200a to the network shown in FIG. 1.

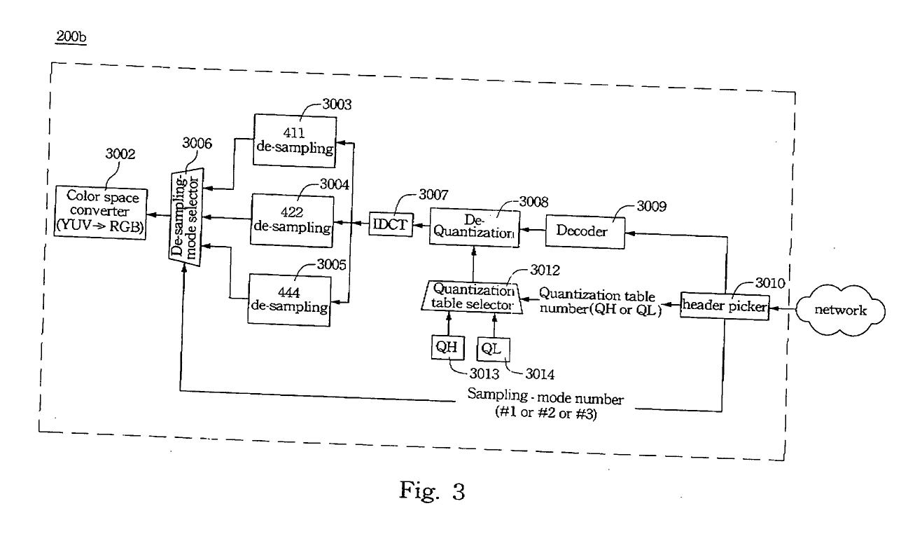

FIG. 3 is a detailed diagram of the system 200b for dynamically adjusting processing data modes in accordance with the present invention. Through the network shown in FIG. 1, the compressed image data is received. A header picker 3010 is used to parse the number included in the header to indicate what kind of quantization table and sampling mode is used. Then, these information are sent to a quantization table selector 3012 and a de-sampling mode selector 3006 to switch corresponding quantization table and de-sampler to decode the received image data.

After the header is parsed, the compressed image data is decoded by a decoder 3009. Then, the decoded image data is transmitted to a de-quantization 3008. Based on the number recorded in the header, a specific quantization table 3013 or 3014 is selected by the quantization table selector 3012 to de-quantize the image data.

Next, the image data is transmitted to an inverse discrete cosine transform (IDCT) 3007. The inverse discrete cosine transform reconstructs a sequence from its discrete cosine transform (DCT) coefficients. The IDCT function is the inverse of the DCT function. The inverse discrete cosine transform performs an inverse Fourier transform to transform an image data from a frequency domain to a spatial domain.

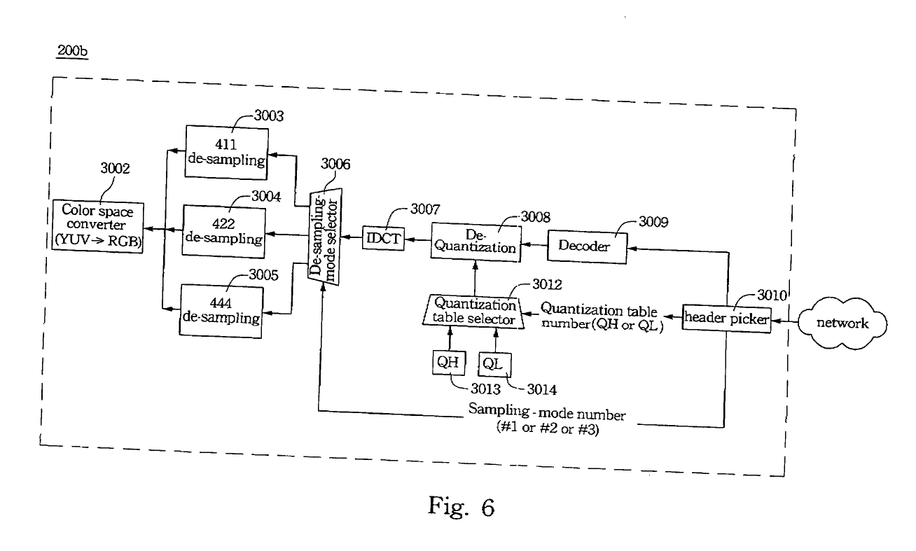

Next, the image data is de-sampled in a selected de-sampling mode. In other words, based on the number recorded in of the header, a specific de-sampler 3003, 3004 or 3005 is selected by the de-sampling mode selector 3006 to process the image data. It is noticed that the de-sampling mode selector 3006 also may be connected between the inverse discrete cosine transform (IDCT) 3007 and the three de-samplers 3003, 3004 and 3005 as shown in the FIG. 6.

The de-sampled image data is transmitted to the color space converter 3002 to transform from luminance/chrominance color space into RGB image data. Finally, the RGB image data is transmitted to the destination devices 102 (shown in the FIG. 1) to reproduce this image.

FIG. 7 illustrates a diagram for determining which sampler and quantization table should be selected.

According to this figure and FIG. 5, when the volume of all motion pixel is located in the area between the threshold 7000 and the threshold 7002, a J1 type compressed format is selected. When the volume of all motion pixel is located in the area between the threshold 7001 and the threshold 7003, a J2 type compressed format is selected. When the volume of all motion pixel is located in the area between the threshold 7002 and the threshold 7004, a J3 type compressed format is selected. When the volume of all motion pixel is located in the area between the threshold 7003 and the threshold 7005, a J4 type compressed format is selected. When the volume of all motion pixel is located in the area between the threshold 7004 and the threshold 7006, a J5 type compressed format is selected. When the motion pixel is located in the area surrounded by the threshold 7006, a J6 type compressed format is selected.

On the other hand, When the volume of all motion pixel is located in the area between the threshold 7001 and the threshold 7002, two types, J1 and J2, of compressed format can be selected. When the volume of all motion pixel is located in the area between the threshold 7002 and the threshold 7003, two types, J2 and J3, of compressed format can be selected. When the volume of all motion pixel is located in the area between the threshold 7003 and the threshold 7004, two types, J3 and J4, of compressed format can be selected. When the volume of all motion pixel is located in the area between the threshold 7004 and the threshold 7005, two types, J4 and J5, of compressed format can be selected. When the volume of all motion pixel is located in the area between the threshold 7005 and the threshold 7006, two types, J5 and J6, of compressed format can be selected.

Reference is made to FIG. 2 and FIG. 7 together. As can be seen from FIG. 7, three are 6 thresholds 7001 through 7006. According to the definition in the FIG. 7, first, the analyzer 2015 statistically caculate the volume of all motioned pixels between the current frame and the previous frame respectively stored in the buffer 2016 and 2018.

Actually, this calculation is based on the residual number from subtractor 2020. A J1 type image compressing process is selected when volume of all the motion pixels is get and located in the area between the threshold 7000 and the threshold 7001. In other words, because the image change is vivid, the largest compression mode, QL quantization table and 411 sampling mode are selected. Therefore, the selector 2006 selects the sampler 2003 and the selector 2012 selects the quantization table 2014 to compress the image data.

When the next image data is grabbed, the analyzer 2015 statistically caculate the volume of all motioned pixels between buffer 2016 and 2018 again. For preventing the selectors 2012 and 2006 from being frequently switched, a J1 type image compressing process is selected again when the volume of all motion pixel is found everywhere and the outermost motion pixel is located in the area between the threshold 7001 and the threshold 7002. Therefore, a compression mode, QL quantization table and 411 sampling mode are selected again. The selector 2006 selects the sampler 2003 and the selector 2012 selects the quantization table 2014 to compress the image data. However, if the volume of all motion pixel is located in the area between the threshold 7002 and the threshold 7003, a J2 type image compressing process is selected. Therefore, a compression mode, QH quantization table and 411 sampling mode are selected. The selector 2006 selects the sampler 2003 and the selector 2013 selects the quantization table 2013 to compress the image data.

In other words, when the volume of all motion pixels is located in those areas in which two types of compressing process are provided for selecting, for preventing the selectors 2012 and 2006 from being frequently switched, the present invention forces the selectors 2012 and 2006 to select the sampler and quantization table that are similar to the previous compressing process. In other words, when the volume of all motion pixels is changed form the area between the threshold 7001 and the threshold 7002 of the previous image data to the area between the threshold 7002 and the threshold 7003 of a next image data, both two compressing process formats are J2 type. When the volume of all motion pixels is changed from the area between the threshold 7000 and the threshold 7001 of the previous image data to the area between the threshold 7002 and the threshold 7003 of a next image data, the compressing process formats are changed from J1 type to J2 type, not J3 type, because J2 type is more similar to J1 type. The rest may be deduced by analogy. For example, when the volume of all motion pixels is changed form the area between the threshold 7002 and the threshold 7003 of the previous image data to the area between the threshold 7004 and the threshold 7005 of a next image data, the compressing process formats are changed form J2 type to J4 type, not J5 type, because J2 type is more similar to J4 type.

In a preferred embodiment, if the display resolution is 640×480 pixels, the area surrounded by the threshold 7000 is 640×480 pixels, the area surrounded by the threshold 7001 is 549×411 pixels (549=640×6/7 and 411=480×6/7), the area surrounded by the threshold 7002 is 457×343 pixels (457=640×5/7 and 343=480×5/7), the area surrounded by the threshold 7003 is 366×274 pixels (366=640×4/7 and 274=480×4/7), the area surrounded by the threshold 7004 is 274×206 pixels (274=640×3/7 and 206=480×3/7, the area surrounded by the threshold 7005 is 183×137 pixels (183=640×2/7 and 137=480×2/7), and the area surrounded by the threshold 7006 is 91×69 pixels (91=640×1/7 and 69=480×1/7). The original point is 0×0. In other words, based on the display resolution, the possible volume of all motioned pixels is divided to seven segments for the compressing format selection consideration.

Accordingly, the present invention provides an image transmission and receiving system that can dynamically adjust the sampling mode and quantization table based on two consecutive image data. Therefore, a most suitable compressing format may be performed in an image data to reduce the compressed data size. Moreover, by the real-time adjusting, the image quality also may be improved.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures.

What is claimed is:

1. A compression system, comprising:
a first memory for storing a first image data;
a second memory for storing a second image data, wherein said first image data and said second image data are consecutive to each other;
an analyzer for sending a first control signal and a second control signal based on comparison of said first image data with said second image data;
a first selector, coupled to a plurality of samplers, for selecting one of said samplers to sample said first image data according to said first control signal, wherein said samplers provide different sampling modes respectively; and
a second selector, coupled to a plurality of quantization tables, for selecting one of said quantization tables to quantize said first image data according to said second control signal.

2. The compression system of claim 1, further comprising a header adder coupled to said two selectors, wherein a specific number is added into a header based on selecting a sampler and a quantization table.

3. The compression system of claim 1, wherein said sampling modes comprise a first sampling mode, a second sampling mode and a third sampling mode.

4. The compression system of claim 1, further comprising a grabber to grab image data to said first memory from a device.

5. The compression system of claim 1, further comprising a swap coupled to said first memory and said second memory for transmitting said second image data from said first memory to said second memory.

6. The compression system of claim 1, further comprising a color space converter coupled to said grabber to transform an image data into a luminance/chrominance color space data.

7. The compression system of claim 6, wherein said color space converter transmits an image data to said first selector to select one of said samplers to sample said image data.

8. The compression system of claim 7, further comprising a discrete cosine transform coupled to said samplers, wherein said discrete cosine transform performs a Fourier transform to transform an image data from a spatial domain to a frequency domain.

9. The compression system of claim 6, wherein said color space converter transmits an image data to said samplers and said first selector selects one of said samplers to sample said image data.

10. The compression system of claim 9, further comprising a discrete cosine transform coupled to said first selector, wherein said discrete cosine transform performs a Fourier transform to transform an image data from a spatial domain to a frequency domain.

11. The compression system of claim 1, further comprising an encoder coupled to said second selector for encoding an image data.

12. The compression system of claim 1, wherein said samplers and said quantization tables determine a plurality of compression combinations, wherein each of said combinations reperesents a specific sampler and a specific quantization table.

13. The compression system of claim 12, wherein a frame is divided into a plurality of blocks with different areas and each of said blocks reperesents a specific compression combination.

14. The compression system of claim 13, wherein one of said blocks is selected based on a volume of all motion pixels between said first image data and said second image.

15. The compression system of claim 14, wherein said analyzer compares said first image data with said second image data to determine said volume of all motion pixels.

16. The compression system of claim 15, wherein some area of any adjacent two blocks overlap each other.

17. The compression system of claim 16, wherein each overlapped area is related to two compression combinations.

18. A decompression system, said system comprising:
a header picker to receive a header with a specific number, wherein said peaker may resolve said number to form a first control signal and a second
a first selector coupled to a plurality of quantization tables for receiving said second control signal to select one of said quantization tables to de-quantize an image data; and
a second selector coupled to a plurality of de-samplers for receiving said first control signal to select one of said de-samplers to de-sample an image data, wherein said de-samplers provide different de-sampling formats respectively.

19. The decompression system of claim 18, wherein said specific number indicates a combination of a specific sampling mode and a specific quantization table.

20. The decompression system of claim 18, further comprising a decoder coupled to said header picker for decoding an image data.

21. The decompression system of claim 18, wherein said de-sampling modes include a first de-sampling mode, a second de-sampling mode and a third de-sampling mode.

22. The decompression system of claim 18, further comprising an inverse discrete cosine transform coupled to said first selector, wherein said inverse discrete cosine transform performs an inverse Fourier transform to transform an image data from a frequency domain to a spatial domain.

23. The decompression system of claim 22, wherein said inverse discrete cosine transform couples with said second selector through said de-samplers.

24. The decompression system of claim 23, further comprising a color space converter coupled to said second selector to transform a color space image data into an RGB image data.

25. The decompression system of claim 22 wherein said inverse discrete cosine transform couples with said de-samplers through said second selector.

26. The decompression system of claim 25, further comprising a color space converter coupled to said de-samplers to transform a color space image data into an RGB image data.

27. A compression method, comprising the steps as follows:
storing a first image data and a second image data, wherein the second image data is successive image data of the first image data;
analysing the first image data and the second image data;
sampling and quantinising said second image data according to a plurality of combination of sampling modes and quantization tables chosen based on the analysis of the first image data and the second image data.

28. The compression method of claim 27, wherein said sampling modes comprise a first sampling mode, a second sampling mode and a third sampling mode.

29. The compression method of claim 27, wherein analysing the first image data and the second image data further comprising to calculate a volume of pixel motion between said first image data and said second image data.

30. The compression method of claim 27, further comprising adding a special number to a header to represent a selected combination of a special sampling mode and quantization table.

31. The compression method of claim 27, further comprising converting said first image data and said second image data into luminance/chrominance color space image data.

32. The compression method of claim 27, further comprising to transform said sampled second image data from a spatial domain to a frequency domain.

33. The compression method of claim 27, further comprising to encode said sampled and quantized second image data transformed to frequency domain.

34. The compression system of claim 1, wherein said samplers and said quantization tables determine a plurality of compression combinations, wherein each of said combinations reperesents a specific sampler and a specific quantization table.

35. A De-compression method, comprising the steps as follows:
receiving a header with a special number to indicate a combination of sampling mode and quantization table; and
de-sampling and de-quantinising an data accorsing to said combination.

36. The decompression method of claim 35, wherein said de-sampling modes comprise a first de-sampling mode, a second de-sampling mode and a third de-sampling mode.

37. The cdeompression method of claim 35, further comprising to transform a dequantized image data from a frequency domaino to a spatial domain.

38. The cdeompression method of claim 35, further comprising to convert a de-sampled from luminance/chrominance color space to an RGB image data.
